(19) United States
(12) Patent Application Publication
(10) Pub. No.: US 2017/0197517 A1
(43) Pub. Date: Jul. 13, 2017

(54) MULTI-MODE CHARGING SYSTEM

(71) Applicant: Elix Wireless Charging Systems Inc., Richmond (CA)

(72) Inventors: Brice JAMIESON, Richmond (CA); Boon C. NG, Vancouver (CA); Vitali TIKHOMOLOV, Vancouver (CA)

(21) Appl. No.: 15/424,568

(22) Filed: Feb. 3, 2017

Related U.S. Application Data
(63) Continuation of application No. PCT/CA2015/050736, filed on Aug. 5, 2015.
(60) Provisional application No. 62/033,748, filed on Aug. 6, 2014.

(51) Int. Cl. B60L 11/18; H02J 7/00; H02J 7/02

(52) U.S. Cl. CPC B60L 11/1825; B60L 11/1816; B60L 11/182; B60L 11/1838; H02J 7/025; H02J 7/0027

(57) ABSTRACT

Currently the most common method on the market to charge electric vehicles is to plug in the electric vehicle to a power source. Wireless charging technologies are also being developed and infrastructure has begun to be rolled out into the marketplace. Designing separate charging systems for wireless and wired systems may lead to drawbacks as not all chargers will be compatible with all vehicles. The invention described herein illustrates a system for bridging the gap between wired and wireless charging infrastructure through the use of a multi-mode electric vehicle charging system capable of delivering power through a plurality of transmission methods, where one of those methods is wireless power transfer.

### RELATED APPLICATIONS

This application is a continuation of Patent Cooperation Treaty application No. PCT/CA2015/050736 filed 5 Aug. 2015 and entitled MULTI-MODE CHARGING SYSTEM, which in turn claims priority from, and the filing date benefit under 35 USC §119 of, U.S. application Ser. No. 62/033,748 filed on 6 Aug. 2014 and entitled METHOD AND APPARATUS FOR A MULTI-MODE CHARGING SYSTEM. The applications referred to in this paragraph are hereby incorporated herein by reference.

### TECHNICAL FIELD

This invention pertains to a method and apparatus for a multi-mode electric vehicle charging system capable of delivering power through a plurality of transmission modes, where at least one of those modes is wireless power transfer. Particular embodiments, provide methods and apparatus for retrofitting wireless electric vehicle chargers into existing electric vehicle charging systems.

### BACKGROUND

Despite the anticipated rollout of wireless charging for electric vehicles (“EVs”), there will be, for the foreseeable future, a simultaneous market for both wired and wireless charging of EVs. Providing separate charging systems for wireless and wired systems (also referred to as plug-in systems) can lead to more drawbacks as not all chargers will be compatible with all vehicles, a problem which standardization in wired vehicle electrical connections (such as the SAE J1772 cable interface) is attempting to solve. It is expected that multiple standards and systems will likely exist simultaneously, and that the technologies underlying these standards may be non-interoperable. There is a general desire to enhance the roll-out of wireless charging infrastructure in a cost-effective manner, while simultaneously maintaining existing wired charging infrastructure and minimizing the amount of costly overlap between the two systems.

There is a general desire to provide charging stations capable of charging a wide variety of electric vehicles through both wireless and wired (i.e. plug-in) charging. There may also be a general desire to provide simple, inexpensive wireless charging systems that can be retrofitted to pre-existing plug-in (i.e. wired) chargers. There may be a general desire to provide charging stations for charging multiple vehicles simultaneously.

### BRIEF DESCRIPTION OF DRAWINGS

Exemplary embodiments are illustrated in referenced figures of the drawings. It is intended that the embodiments and figures disclosed herein are to be considered illustrative rather than restrictive.

FIG. 1 is a schematic illustration of a multi-mode charging station for a single vehicle according to a particular embodiment.

FIG. 2 is a schematic illustration of a multi-mode charging station for a single vehicle according to a particular embodiment.

FIG. 3 is a schematic illustration of a multi-mode charging station for supplying power from wired and wireless chargers to an electric vehicle according to a particular embodiment.

FIG. 4 is a schematic illustration of a multi-mode charging station for supplying power to multiple electric vehicles according to a particular embodiment.

FIG. 5 is a schematic illustration of a multi-mode charging station for supplying power from multiple wired chargers to electric vehicles according to a particular embodiment.

FIG. 6 is a schematic illustration of a multi-mode charging station for supplying power from multiple power sources to multiple electric vehicles at a single secondary charging station according to a particular embodiment.

FIG. 7 is a schematic illustration of a multi-mode charging station for supplying power from multiple power sources to multiple electric vehicles from a plurality of wired and wireless charging systems according to a particular embodiment.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

One aspect of the invention provides an electric vehicle charging station. An electric vehicle supply equipment (EVSE) unit may be connected to a power source and configured to provide output power. The EVSE unit may comprise any EVSE unit as known in the art. For example, the EVSE unit may be configured to enhance safety by enabling two-way communication between the charging station and the electric vehicle. Two-way communication may ensure that current passed to the vehicle is below limits of the power source and what the vehicle can receive. The EVSE unit may comprise conductors, including ungrounded, grounded and equipment grounding conductors, electric vehicle connectors, attachments plugs, and other fittings, devices, power outlets or apparatuses installed for the purpose of delivering power from a power source (e.g. the power grid) to the electric vehicle. A plug-in (i.e. wired) charger may be electrically connected (e.g. through a wired connection) to the EVSE unit to receive output power therefrom. The plug-in charger may comprise any type of wired or plug-in charger that is known in the art. For example, the plug-in charger may comprise an output connector according to at least any of the following standards: an SAE J1772 output connector, a CHAdeMO output connector, a Tesla Motors Supercharger output connector or any other plug-in charger that is physically electrically connectable (i.e. can be unconnected and reconnected) to an electric vehicle for transferring power from the EVSE unit to the electric vehicle. A wireless charger may be physically electrically connectable (e.g. through a wired connection) to the EVSE unit to receive power therefrom. The wireless charger may comprise any type of wireless charger that is known in the art such as an induction charger or a magneto-dynamic coupling (MDC) charger that is wirelessly electrically connectable to an electric vehicle for transferring power from the EVSE unit to the electric vehicle. Examples of MDC chargers are provided in PCT application No. PCT/CA2010/000252 (published under WO/2010/096917) and PCT application No. PCT/CA2015/050327, both of which are hereby incorporated herein by reference. In some embodiments, the wireless charger is electrically connectable to the EVSE unit via the plug-in charger (e.g. an output connector of the plug-in charger is connected to an input connector of the wireless charger to thereby transfer at least a portion of the output power from the EVSE unit to the wireless charger).

In some embodiments, the electric vehicle charging station comprises a secondary charger distribution panel electrically connectible to the EVSE unit to receive power therefrom. For example, the secondary charger distribution panel may be electrically connectable to the EVSE unit via the plug-in charger (e.g. an output connector of the plug-in charger is connected to an input connector of the secondary charger distribution panel to thereby transfer power from the EVSE unit to the secondary charger distribution panel). The secondary charger distribution panel may also be connected to the wireless charger to provide power from the EVSE unit thereto and to at least one secondary charger to provide power from the EVSE unit thereto. In some embodiments, the secondary chargers comprise one or more secondary plug-in chargers physically electrically connectable to an electric vehicle for transferring power from the EVSE unit to the electric vehicle. The secondary plug-in chargers may comprise any type of wired or plug-in charger that is known in the art. For example, the secondary plug-in chargers may comprise an output connector according to any of at least the following standards: an SAE J1772 output connector, a CHAdeMO output connector, a Tesla Motors Supercharger output connector or any other plug-in charger that is physically electrically connectable to an electric vehicle for transferring power from the EVSE unit to the electric vehicle. In some embodiments, the secondary chargers comprise one or more secondary wireless chargers wirelessly electrically connectable to an electric vehicle for transferring power from the EVSE unit to the electric vehicle. The secondary wireless chargers may comprise any type of wireless charger that is known in the art such as an induction charger or a magneto-dynamic coupling (MDC) charger that is wirelessly electrically connectable to an electric vehicle for transferring power from the EVSE unit to the electric vehicle. Examples of MDC chargers are provided in PCT application No. PCT/CA2010/000252 (published under WO/2010/096917) and PCT application No. PCT/CA2015/050327. In some embodiments, secondary chargers may comprise one or more secondary plug-in chargers and one or more secondary wireless chargers. The secondary plug-in chargers may each be of the same type or may each be of different types. Similarly, the secondary wireless chargers may each be of the same type or may each be of different types.

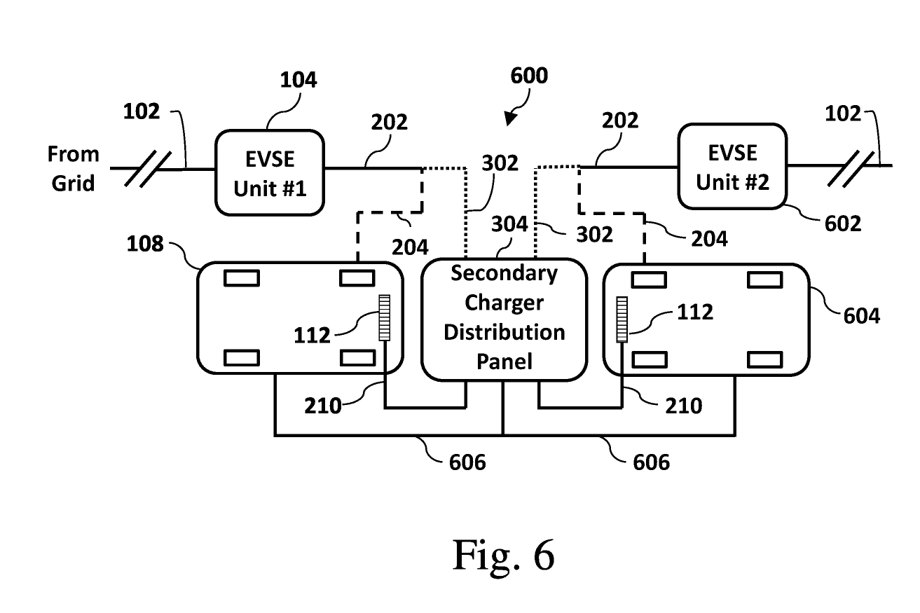

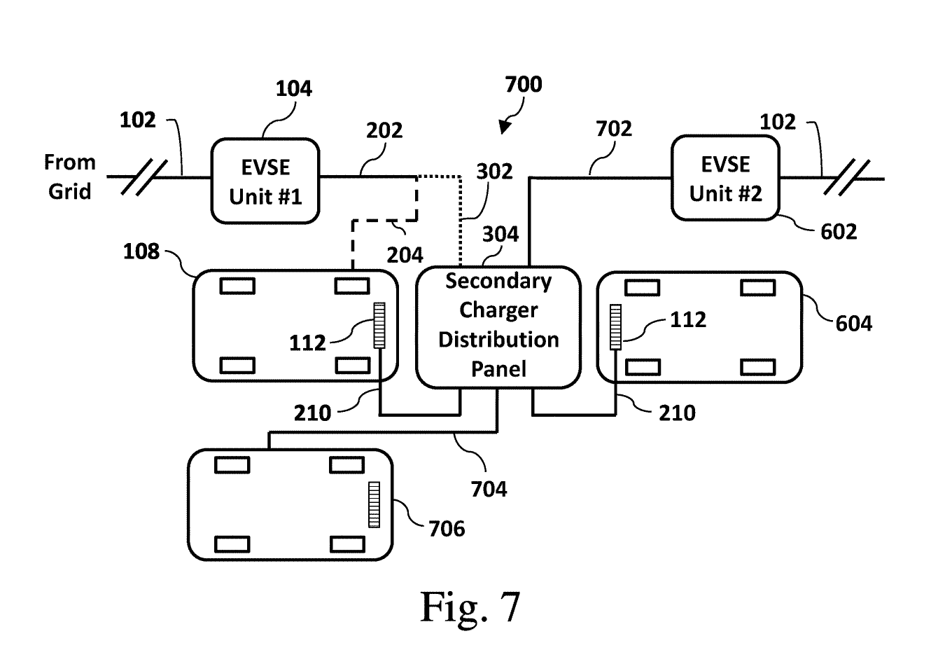

In some embodiments, there is more than one power source to provide output power to the charging station. For example, in some embodiments, there are two power sources to provide power to the charging station and there is a corresponding EVSE unit for each power source (e.g. see FIG. 6 or 7). The output power from both EVSE units may be directed to a secondary charger distribution panel. The secondary charger distribution panel may then distribute the output power from the first EVSE unit and the second EVSE unit combined or separately to each of the wireless charger and secondary chargers. In some embodiments, the secondary charger distribution panel may limit how much output power is drawn from a particular EVSE unit (and corresponding power source) according to limitations of the power source and/or the required power output.

In some embodiments, the secondary charger distribution panel is configurable to distribute the output power (from one or more EVSE units and/or power sources) to the wireless charger and secondary chargers according to a distribution ratio. The distribution ratio may be based at least in part on the capacity of the wireless charger, the capacity of one of the secondary chargers, the state of charge of one or more of the vehicles, user input, a desirability to share output power between vehicles using a charging station and/or any other relevant factors.

Another aspect of the invention provides an electric vehicle wireless power charger that is retrofittable to a pre-existing wired (i.e. plug-in) electric vehicle charger and a method for installing the wireless charger. The wireless power charger may comprise a wireless power transmitter as is known in the art such as an inductive wireless transmitter or an MDC wireless transmitter. The wireless transmitter may comprise a power input connector according to any of at least the following standards: an SAE J1772 input connector, a CHAdeMO input connector, a Tesla Motors Supercharger input connector or any other plug-in charger that is physically electrically connectable to a plug-in charger for transferring power from the plug-in charger. In this way, the wireless transmitter is physically electrically connectable to a pre-existing plug-in charger having an output connector according to any of at least the following standards: an SAE J1772 output connector, a CHAdeMO output connector, a Tesla Motors Supercharger output connector or any other plug-in charger that is physically electrically connectable to an electric vehicle for transferring power to an electric vehicle. By connecting the pre-existing plug-in charger outlet connector into the input connector of the wireless charger, power from the plug-in charger, which may come from an EVSE unit (although this is not mandatory) may be transferred to the wireless charger.

Another aspect of the invention provides a method for charging an electric vehicle when the electric vehicle is located in proximity to an electric vehicle charging station. The charging station may for example be a charging station according to any of the embodiments herein. The charging station comprises a plug-in charger to which power is provided. The plug-in charger may be physically electrically connectable to an electric vehicle to provide power thereto. The plug-in charger may comprise any type of wired or plug-in charger that is known in the art. For example, the plug-in charger may comprise an output connector according to at least any of the following standards: an SAE J1772 output connector, a CHAdeMO output connector, a Tesla Motors Supercharger output connector or any other plug-in charger that is physically electrically connectable to an electric vehicle for transferring power to the electric vehicle. The charging station also comprises a wireless charger to which power is provided. The wireless charger may be wirelessly electrically connectable to an electric vehicle to provide power thereto. The wireless charger may comprise any type of wireless charger that is known in the art such as an induction charger or a magneto-dynamic coupling (MDC) charger that is wirelessly electrically connectable to an electric vehicle for transferring power to the electric vehicle. Examples of MDC chargers are provided in PCT application No. PCT/CA2010/000252 (published under WO/2010/096917) and PCT application No. PCT/CA2015/050327. A vehicle is charged by one or more of: a physical connection of the plug-in charger to the electric vehicle and a wireless electrical connection of the wireless charger to the electric vehicle.

For example, in one embodiment, the wireless charger is electrically connected to a power source via the plug-in charger, such as is described above and depicted in FIG. 2, for example. In this way, power is provided to both the plug-in charger and the wireless charger. A car may then be charged via the wireless charger. In another example, the charging station comprises a plug-in charger that is not connected to the wireless charger. To charge the vehicle wirelessly, the charging station is switched from a first configuration in which power is only provided to the plug-in charger, to a second configuration in which power is provided to the wireless charger (e.g. by connecting the wireless charger to the power source via the plug-in charger). The electric vehicle may then be charged via the wireless charger. In a further example still, the charging station may comprise a wireless charger connected to a power source and a plug-in charger separately connected to a power source wherein power is provided to both simultaneously so that a vehicle can be charged by either or both of the wireless charger or the plug-in charger without switching configurations.

In some embodiments, the wireless charging station comprises at least one secondary charger. The secondary charger may comprise a secondary wireless charger or a secondary plug-in charger. For example, the secondary plug-in charger may comprise an output connector according to at least any of the following standards: an SAE J1772 output connector, a CHAdeMO output connector, a Tesla Motors Supercharger output connector or any other plug-in charger that is physically electrically connectable to an electric vehicle for transferring power to the electric vehicle. The secondary wireless charger may be wirelessly electrically connectable to an electric vehicle to provide power thereto. The secondary wireless charger may comprise any type of wireless charger that is known in the art such as an induction charger or a magneto-dynamic coupling (MDC) charger that is wirelessly electrically connectable to an electric vehicle for transferring power to the electric vehicle. Examples of MDC chargers are provided in PCT application No. PCT/CA2010/000252 (published under WO/2010/096917) and PCT application No. PCT/CA2015/050327. The method may comprise charging a vehicle by one or more of: a physical connection of the plug-in charger to the electric vehicle and a wireless electrical connection of the wireless charger to the electric vehicle.

In some embodiments, the method comprises providing power to any combination of the plug-in charger, the wireless charger and the secondary chargers. The power may be distributed according to a distribution ratio based at least in part on one or more of the capacity of the wireless charger, the capacity of one of the secondary chargers, the state of charge of one or more of the vehicles, user input and any other relevant factors. One or more of the plug-in charger, the wireless charger and the secondary chargers may be powered simultaneously to charge one or more vehicles simultaneously. In some embodiments, the method comprises combining or separating power from multiple power sources and distributing the combined or separated power from multiple power sources to one or more of the plug-in charger, the wireless charger and the secondary chargers.

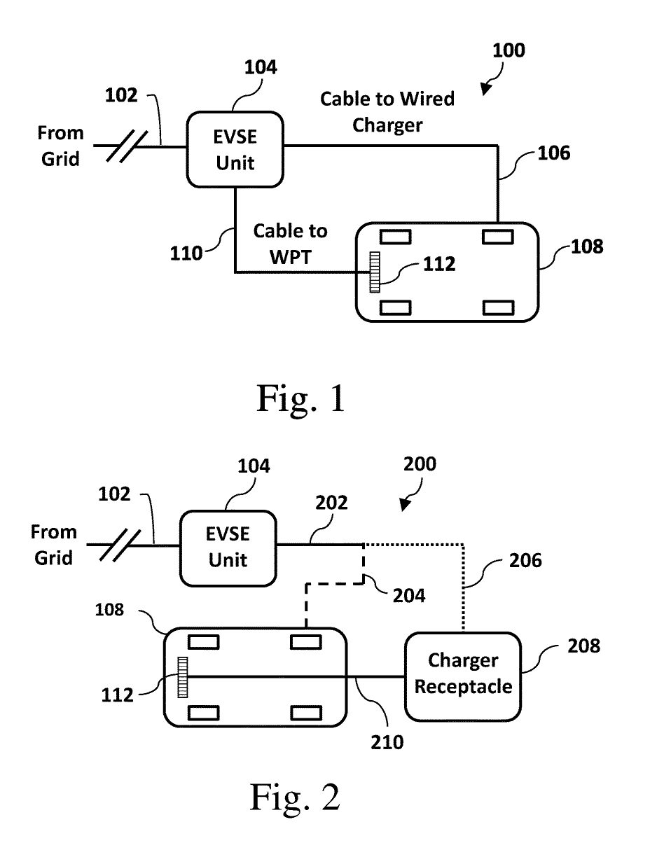

FIG. 1 depicts a multi-mode charging station 100 for charging one electric vehicle at a time. In charging station 100 of the FIG. 1 embodiment, power from the grid 102 is supplied to an EVSE unit 104. Station 100 comprises a cable 106 EVSE unit 104 capable of being directly plugged into (i.e. physically electrically connectable to) an electric vehicle (EV) 108 to charge EV 108 by providing power from EVSE unit 104 to EV 108. Cable 106 (at its end distal from EVSE unit 104) may comprise: a SAE J1772 output connector; a CHAdeMO output connector; a Tesla Motors Supercharger output connector and/or a similar standardized connector for connection to EV 108. In charging station 100 of the FIG. 1 embodiment, station 100 comprises an additional cable 110 that provides power from EVSE unit 104 to an additional power transmission system such as a wireless power transmission (WPT) system 112 (i.e. a wireless charger). WPT unit 112 may comprise an inductively coupled wireless power transfer charging system, a magnetically coupled (i.e. MDC) wireless power transfer charging system and/or some other form of wireless charging system for charging EV 108. EVSE unit 104 may deliver output power to EV 108 through plug-in cable 106 (i.e. a physical electrical connection), through WPT unit 112 (i.e. a wireless electrical connection) and/or through a combination of both, as may occur in the case when EV 108 is rated for Level 1 charging (corresponding to a power level of 3.3 kW) via charging cable 106 and WPT unit 112 individually, leading to the power sum capability of the EV 108 to accept a total charging power of 6.6 kW (or the equivalent Level 2 charging standard of 7 kW) when both cable 106 and WPT unit 112 are used simultaneously. In the FIG. 1 embodiment, EVSE unit 104 may split power output, driving charging cable 106 and WPT unit 112 with a desired amounts of power (e.g. at 3.3 kW each). Optionally, EVSE unit 104 may deliver the full available power to either charging cable 106 or to WPT unit 112, depending on the charging method selected by the user. In a different configuration of the FIG. 1 embodiment, a plurality of charging systems may be present and connected to EVSE unit 104 to facilitate simultaneous charging of a plurality of EVs 108. Each such charging system may comprise a plug-in cable 106 and a WPT unit 112 for delivering power from EVSE unit 104 to a corresponding EV 108 via either a physical electrical connection (plug-in cable 106) or a wireless connection (WPT unit 112). Power may be delivered via any single system or a combination of these systems depending on the output method desired by the user. The FIG. 1 embodiment has several advantages. Firstly it allows EVs 108 with or without a wireless charging capabilities to still charge through the same EVSE unit 104 and at the same charging station 100. Secondly, the FIG. 1 embodiment provides diversity against any one charging technique becoming defective (e.g. damage to the charging cable).

FIG. 2 depicts a multi-mode charging station 200 for charging one electric vehicle at a time. In multi-mode charging station 200 of the FIG. 2 embodiment, output power is supplied from the grid 102 to an EVSE unit 104. In contrast to the FIG. 1 embodiment (which comprises two separate cables 106, 110 to either plug into EV (plug-in cable 106) or to power a WPT unit 112 (cable 110)), station 200 of the FIG. 2 embodiment comprises a single cable 202 which provides an interface between EVSE unit 104, a wired (i.e. plug-in) charging system for charging EV 108 and a wireless charging system for charging EV 108. Charging station 200 may comprise a plurality of wired connections to EVSE unit 104 (each similar to cable 202), but for clarity and ease of description, the illustrated FIG. 2 charging station 200 is shown with a single cable 202. In a first possible configuration 204 (represented by dashed lines) of cable 202, cable 202 may be directly plugged in (i.e. physically electrically connected to) an EV 108. Cable 202 (at its end distal from EVSE unit 104) may comprise a SAE J1772 output connector, a CHAdeMO output connector, a Tesla Motors Supercharger output connector and/or some other form of standardized plug-in connector. In a second possible configuration 206 (represented by dotted lines) of cable 202, cable 202 may be plugged into a charger receptacle 208 (which may be provided at a suitable location in station 200) where charger receptacle 208 is further physically electrically connected (via cable 210) to a WPT unit 112. WPT unit 112 may comprise an inductively coupled wireless power transfer charging system, a magnetically coupled (i.e. MDC) wireless power transfer charging system and/or some other form of wireless charging system for charging EV 108. Charger receptacle 208 may comprise a standard input connector (similar to those provided on EVs), such as an input connector corresponding to the SAE J1772 standard, the CHAdeMO standard, the Tesla Motors Supercharger standard and/or some other form of standardized plug-in connector. A corresponding output connector of cable 202 may be plugged into charger receptacle 208 to provide electrical power to WPT unit 112. In the FIG. 2 embodiment, system 200 comprising a single EVSE output cable 202 cannot deliver power simultaneously to EV 108 via a physical (plug-in) electrical connection and via a wireless connection. When it is elected to charge EV 108 via wired power transfer, cable 202 is plugged directly into EV 108 (as shown in configuration 204), which means that (in the absence of a second cable from EVSE unit 104 to charger receptacle 208), WPT unit 112 is unpowered. When it is elected to charge EV 108 via wireless power transfer, cable 202 is plugged into charger receptacle 208, thereby providing power to WPT unit 112. The FIG. 2 embodiment also encompasses the scenario where a WPT unit 112 is added (i.e. retrofitted) to an existing EVSE unit 104. This allows for the possibility for existing and more commonly found single-mode wired charging systems to be retrofitted with a wireless charging system to create a multi-mode charging system.

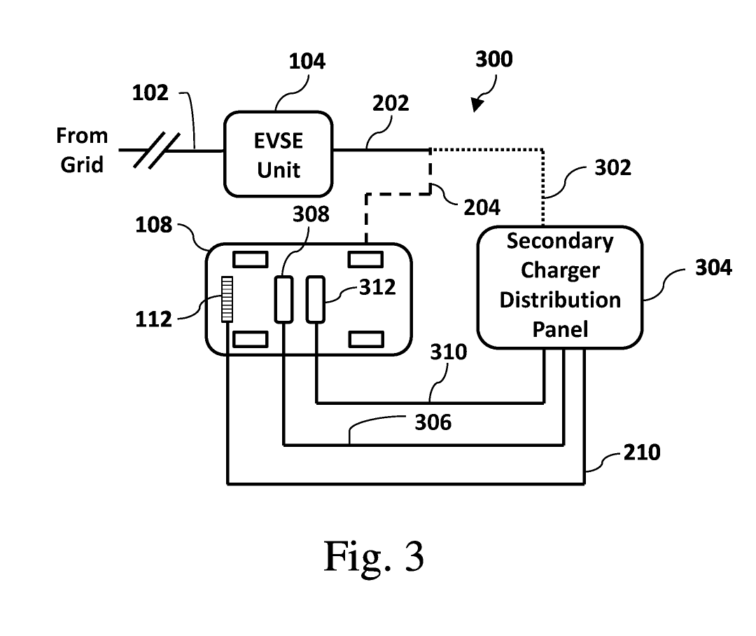

FIG. 3 depicts a multi-mode charging station 300 for supplying output power from wired (i.e. plug-in) and wireless chargers to EV 108. In charging station 300 of the FIG. 3 embodiment, a plurality of secondary power transmission systems may be powered from a secondary power charger distribution panel 304. Secondary power charger distribution panel 304 may comprise a standardized input connector (similar to those of charger receptacle 208 described above in connection with the FIG. 2 embodiment) for connection to a corresponding output connector of plug-in cable 202 from EVSE unit 104. Secondary power charger distribution panel 304 may then distribute power as between the secondary power transmission systems, as described in more detail below. In charging station 300 of the FIG. 3 embodiment, power is supplied from the grid 102 to EVSE unit 104. Charging station 300, of the illustrated embodiment, comprises cable 202 which (like system 200 of FIG. 2) provides the interface between EVSE unit 104, a wired (i.e. plug-in) connection to EV 108 and multiple secondary wireless charging systems which may be used to charge EV 108. Charging station 300 may comprise a plurality of wired connections to EVSE unit 104 (each similar to cable 202), but for clarity and ease of description, the illustrated FIG. 3 charging station 300 is shown with a single cable 202. In a first possible configuration 204 (represented by dashed lines) of cable 202, cable 202 may be directly plugged in (i.e. physically electrically connected to) an EV 108. Cable 202 (at its end distal from EVSE unit 104) may comprise a SAE J1772 output connector, a CHAdeMO output connector, a Tesla Motors Supercharger output connector and/or some other form of standardized plug-in connector. In a second possible configuration 302 (represented by dotted lines) of cable 202, cable 202 may be plugged into secondary charger distribution panel 304 (which may be provided at a suitable location in station 200) where secondary charger distribution panel 304 is further physically electrically connected (via cables 210, 306, 310) to WPT units 112, 308, 312. WPT units 112, 308, 312 may comprise two or different types of WPT units, although this is not necessary. In the illustrated FIG. 3 embodiment, secondary charger distribution panel 304 provides power to three WPT units 112, 308, 312. In general, however, secondary charger distribution panel 304 may provide power to any suitable number of WPT units and/or wired (plug-in) charging systems (not shown). Secondary charger distribution panel 304 allows for the capability to provide charging station 300 with multiple different types of wireless or wired charging systems comprising various technologies. In the illustrated FIG. 3 embodiment, WPT units 112, 308, 312 which receive power from secondary charger distribution panel 304 are used to power a single EV 108, but this is not necessary. It will be appreciated that WPT units 112, 308, 312 could provide power to multiple EVs 108. Charging station 300 of the FIG. 3 embodiment is versatile and can be retrofitted to an existing charging station in a manner similar to that of charging system 200 described above. Charging system 300 is also capable of being upgraded at a later time with to-be-developed wireless charging systems or wired standards by plugging suitable cables into secondary charger distribution panel 304 for supplying power to the new charging technologies and, possibly, by adding appropriate power conversion hardware to secondary charger distribution panel 304.

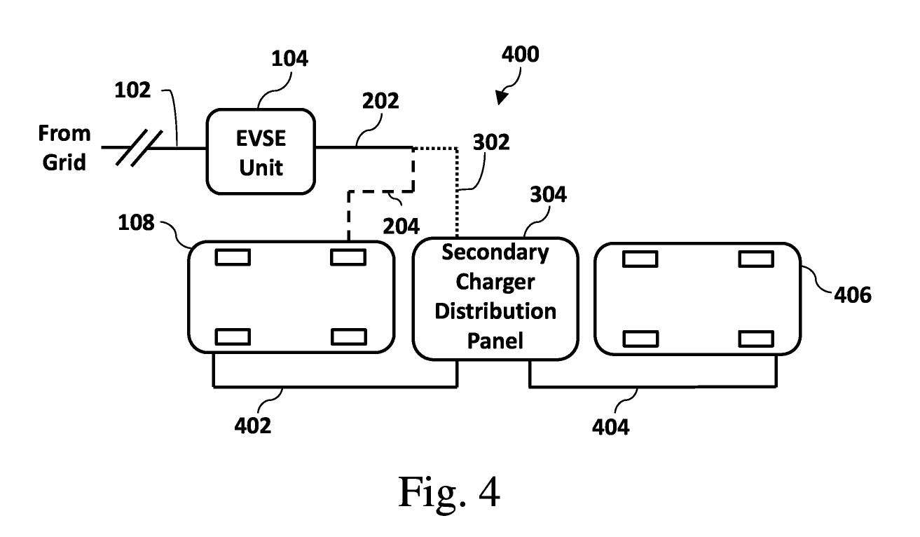

FIG. 4 depicts a multi-mode charging station 400 for supplying output power from multiple wired (i.e. plug-in) chargers to electric vehicles 108, 406. Charging station 400 of the FIG. 4 embodiment comprises a plurality of wired (plug-in) charger cables 402, 404 to supply power from EVSE unit 104, via secondary charger distribution panel 304 to EVs 108, 406. In many respects, charging station 400 is similar to charging station 300 described above. Charging station 400 of the FIG. 4 embodiment differs from charging station 300 of the FIG. 3 embodiment in that charging station 400 comprises wired (plug-in) charger cables 402, 404 delivering power from secondary charger distribution panel 304 to EVs 108, 406 and in that charging station 400 is explicitly shown with multiple EVs 108, 406. Cables 402, 404 may comprise (at their ends distal from secondary charger distribution panel 304) any of the standard output connectors described herein for connection to corresponding input connectors on EVs 108, 406. These output connectors can comprise one or more different types of output connectors, although this is not necessary. In some embodiments, charging system 400 can comprise different numbers of plug-in cables (similar to cables 402, 404) for charging a suitable number of EVs. Charging system 400 may comprise interlocks (not explicitly shown) to ensure safe disconnection of one or more of the wired connections to enable wired EV charging without significant interruption to the EVs 108, 406.

It will be appreciated by those skilled in the art from the description of the embodiments of FIGS. 3 and 4, that one or more plug-in charging cables (similar to plug-in cables 402, 404 of charging system 400) could be added to the FIG. 3 charging system 300 and that one or more WPT units (similar to WPT units 112, 308, 312) could be added to the FIG. 4 charging system 400.

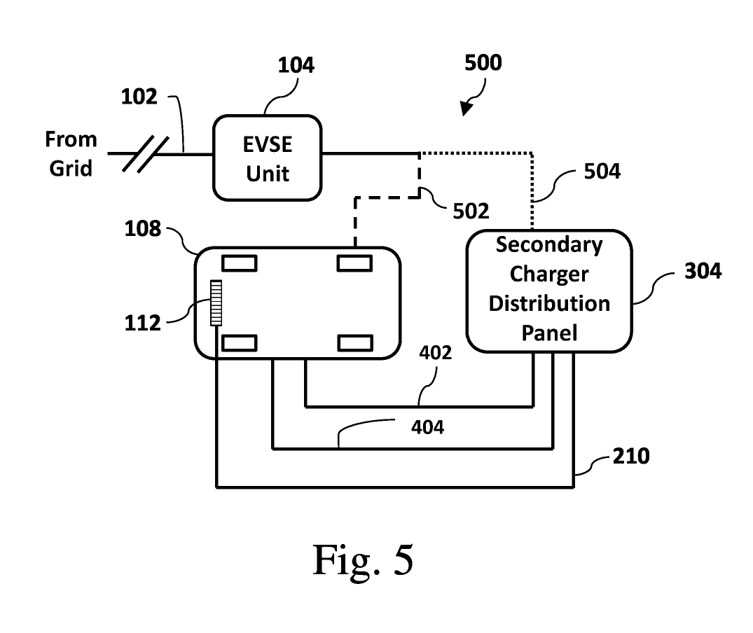

FIG. 5 depicts a multi-mode charging station 500 for supplying output power from multiple wired (i.e. plug-in) chargers and one or more WPT units 112 to one or more electric vehicles 108 (represented in the FIG. 5 illustration by a single EV 108). Charging station 500 of the illustrated FIG. 5 embodiment comprises a plurality of wired (plug-in) charger cables 402, 404 and one or more WPT units 112 to supply power from EVSE unit 104, via secondary charger distribution panel 304, to one or more EVs 108. In many respects, charging station 500 is similar to charging stations 300, 400 described above. Charging station 500 of the FIG. 5 embodiment differs from charging stations 300, 400 of the FIG. 3 and FIG. 4 embodiments in that charging station 500 explicitly comprises wired (plug-in) charger cables 402, 404 for delivering power from secondary charger distribution panel 304 to EVs 108 via physical electrical connection and one or more WPT units 112 for power from secondary charger distribution panel 304 to EVs 108 via wireless electrical connection. Although only one WPT unit 112 is shown in the FIG. 5 illustration, it will be appreciated that system 500 could comprise a plurality of WPT units, which my be of the same WPT type or different WPT types. Plug-in charging cables 402, 404 may comprise (at their ends distal from secondary charger distribution panel 304) any of the standard output connectors described herein for connection to corresponding input connectors on EVs 108. These output connectors can comprise one or more different types of output connectors, although this is not necessary. In some embodiments, charging system 500 can comprise different numbers of plug-in cables (similar to cables 402, 404) for charging a suitable number of EVs. Charging system 500 may comprise interlocks (not explicitly shown) to ensure safe disconnection of one or more of the wired connections to enable wired EV charging without significant interruption to EV 108.

Charging station 500 of the FIG. 5 embodiment also differs from charging stations 300, 400 in that charging station 500 comprises a plurality (e.g. two) cables 502, 504 which are physically electrically connected to EVSE unit 104 for receiving power therefrom. Each of cables 502, 504 is a plug-in charging cable which comprises (at its end distal from EVSE unit 104) any of the standard output connectors described herein for connection to corresponding input connectors on EV 108. As shown in the illustrated embodiment, one of cables 502, 504 (e.g. cable 502) may be directly plugged into EV 108 for physically electrically charging EV 108 and the other one of cables 502, 504 (e.g. cable 504) may be plugged into secondary charger distribution panel 304 to provide a physical electrical connection from EVSE unit 104 to secondary charger distribution panel 304. It will be appreciated that any of the embodiments described herein which comprise a secondary charger distribution panel 304, may be provided with multiple plug-in charging cables (similar to cables 502, 504) which receive power from EVSE unit 104 and that such plug-in charging cables may be additional to or alternative to plug-in cable 202 described in some of the embodiments herein.

In the scenario of the FIG. 5 system 500, where one cable (e.g. cable 502) is physically electrically connected to a receptacle on an EV 108 for charging EV 108 and one cable (e.g. cable 504) is connected to a receptacle of secondary charge distribution panel 304, power may be distributed between the wired connections (provided by cables 502, 504) at a distribution ratio dependent on one or more of: the capacity of the wired connections and their corresponding cables, the presence of wireless charging ability in the EVs which may be connected to receive power, the battery state of EVs connected to receive power and/or the like. For example, if the battery state of one EV 108 is less charged than the battery state of a second EV 108 and there is not sufficient power output by EVSE unit 104 to charge both EVs 108 at a maximum power, additional power may be directed to the EV 108 with the lower charge battery state. In this embodiment, a load balancing controller (not explicitly shown) may be employed in EVSE unit 104 or as an add-on connected between EVSE unit 104 and cables 502, 504 to determine the optimum power through each of the wired (i.e. plug-in) connections 502, 504 to ensure suitable and/or maximum power reaches EVs 108. Such a load-balancing controller may additionally monitor and log power consumed by and delivered to each EV 108 such as for billing purposes.

FIG. 6 depicts a multi-mode charging station 600 for supplying output power to multiple electric vehicles 108, 604 from a single secondary charger distribution panel 304. In charging station 600 of the FIG. 6 embodiment, secondary charger distribution panel 304 is connected to receive power from EVSE unit 104 in a manner similar to that of the embodiments shown in FIGS. 3 and 4 described above. In charging station 600 of the FIG. 6 embodiment, secondary charger distribution panel 304 is also optionally connected to a second EVSE unit 602 for receiving power therefrom. In the illustrated embodiment, second EVSE unit 602 is connected to secondary charge distribution panel 304 via a cable 202 that is similar to cable 202 described elsewhere herein. However, it will be appreciated that, in other embodiments, secondary charge distribution panel 304 may be connected to EVSE units 104, 602 in a manner similar to that in charging system 500 of FIG. 5. In the illustrated FIG. 6 embodiment, secondary charger distribution panel 304 is connected to a plurality of WPT units 112 for wireless connection to charge EVs 108, 604 and to a plurality of wire plug-in charging cables 606 for physical connection to charge EVs 108, 604. It will be appreciated that WPT units 112 and plug-in cables 606 may comprise any of the features of WPT units and plug-in cables described elsewhere herein and that the number of WPT units 112 and plug-in cables 606 may vary.

FIG. 7 depicts a multi-mode charging station 700 for supplying output power to multiple electric vehicles 108, 604, 706 from a single secondary charger distribution panel 304. In charging station 700 of the FIG. 7 embodiment, secondary charger distribution panel 304 is connected to receive power from EVSE unit 104 in a manner similar to that of the embodiments shown in FIGS. 3 and 4 described above. In charging station 700 of the FIG. 7 embodiment, secondary charger distribution panel 304 is also optionally connected to a second EVSE unit 602 for receiving power therefrom. In the illustrated embodiment, second EVSE unit 602 is connected to secondary charge distribution panel 304 via a cable 702. Cable 702 of the illustrated embodiment is a dedicated cable from EVSE unit 602 to secondary charger distribution panel 304, but this is not necessary. In some embodiments, cable 702 may additionally or alternatively comprise a cable similar to cable 202 described elsewhere herein. It will be appreciated that, in other embodiments, secondary charge distribution panel 304 may be connected to EVSE units 104, 602 in a manner similar to that in charging system 500 of FIG. 5. In the illustrated FIG. 7 embodiment, secondary charger distribution panel 304 is connected to a plurality of WPT units 112 for wireless connection to charge EVs 108, 604, 706 and to one or more plug-in charging cables 704 for physical connection to charge EVs 108, 604, 706. It will be appreciated that WPT units 112 and plug-in cables 704 may comprise any of the features of WPT units and plug-in cables described elsewhere herein and that the number of WPT units 112 and plug-in cables 704 may vary.

In an additional aspect of the various embodiments described herein, a notification system (not shown) may be present to identify to the end user or operator if a specific charge delivery technique is currently not configured to deliver power, such as in the case, for example, where a previous user did not correctly reconnect the power cable to the standard receptacle (i.e. output connector), where the system may be damaged leaving the secondary charging system unable to draw power from the EVSE unit and/or the like. This notification system may include, but not be limited to, visual, audible, or electronic notifications delivered to a portable electronic device or to the dashboard of the EV.

In a further aspect of the embodiments described herein, a secondary charging system may be provided which does not include wireless power transmission but takes, at its input, power from a standard output receptacle and delivers it to a vehicle via a different technique or in a different format, such as the case where a charging system takes a standard high-power DC connection as its input and, through an internal inverter, delivers AC power to an EV through a wired connection or where a system takes high-power AC through a standard input or plurality of inputs and rectifies it to DC power which is delivered to an EV. This includes the scenario where a plurality of low-power AC units may be connected via standard connections to a secondary module which rectifies and combines the power into a high-power DC connection.

In another aspect of the embodiments described herein, a secondary charging system which draws power from vehicles (i.e. discharges the vehicles) connected to the charging system in a vehicle-to-vehicle network, where some power is drawn (i.e. discharged) from an existing vehicle over a wireless power connection to charge another EV. This embodiment is a variation of vehicle to grid (V2G) applications where instead of having EVs providing excess electrical power to the grid (such as for credit), EVs can provide direct electrical power to other EVs via wireless power transfer.

It will be apparent to those skilled in the technology of wireless power charging systems that numerous changes and modifications can be made in the preferred embodiments of the invention described above without departing from the scope of the invention. Accordingly, the foregoing description is to be construed in an illustrative and not in a limitative sense.

What is claimed is:

1. An electric vehicle charging station comprising:
a first electric vehicle supply equipment unit connected to a first power source and configured to provide output power;
a plug-in charger electrically connected to the first electric vehicle supply equipment unit to receive power therefrom and physically electrically connectable to an electric vehicle for physically transferring power from the electric vehicle supply equipment unit to the electric vehicle;
a wireless charger electrically connectable to the first electric vehicle supply equipment unit to receive power therefrom and wirelessly electrically connectable to an electric vehicle for wirelessly transferring power from the first electric vehicle supply equipment to the electric vehicle.

2. An electric vehicle charging station according to claim 1 comprising a secondary charger distribution panel electrically connectable to the first electric vehicle supply equipment unit to receive power therefrom and electrically connected to the wireless charger to provide power thereto, the secondary charger distribution panel further physically electrically connected to at least one secondary charger to provide power thereto.

3. An electric vehicle charging station according to claim 2 wherein the at least one secondary charger comprises one or more secondary plug-in chargers electrically connected to the first electric vehicle supply equipment unit, via the secondary charger distribution panel, to receive power therefrom and physically electrically connectable to an electric vehicle for transferring power from the first electric vehicle supply equipment unit to the electric vehicle.

4. An electric vehicle charging station according to claim 2 wherein the at least one secondary charger comprises one or more secondary wireless chargers electrically connected to the first electric vehicle supply equipment unit, via the secondary charger distribution panel, to receive power therefrom and wirelessly electrically connectable to an electric vehicle for transferring power from the first electric vehicle supply equipment to the electric vehicle.

5. An electric vehicle charging station according to claim 1 comprising:
a second electric vehicle supply equipment unit connected to a second power source and configured to provide secondary output power; and
a secondary charger distribution panel electrically connectable to the first electric vehicle supply equipment unit and the second electric vehicle supply unit to receive the output power and the secondary output power therefrom and electrically connected to the wireless charger to provide power from one or both of the first and second electric vehicle supply equipment units to the wireless charger, the secondary charger distribution panel further electrically connected to at least one secondary charger to provide power from one or both of the first and second electric vehicle supply equipment units to the secondary charger.

6. An electric vehicle charging station according to claim 5 wherein the secondary charger distribution panel is configurable to provide only the output power from the first electric vehicle supply equipment unit to one or both of the wireless charger and the at least one secondary charger.

7. An electric vehicle charging station according to claim 5 wherein the secondary charger distribution panel is configurable to provide only the additional output power from the second electric vehicle supply equipment unit to one or both of the wireless charger and the at least one secondary charger.

8. An electric vehicle charging station according to claim 5 wherein the secondary charger distribution panel is configurable to provide power from both the first and second electric vehicle supply equipment units to one or both of the wireless charger and the at least one secondary charger.

9. An electric vehicle charging station according to claim 1 wherein the wireless charger is electrically connectable to the first electric vehicle supply equipment unit via the plug-in charger.

10. An electric vehicle charging station according to claim 2 wherein the secondary charger distribution panel is electrically connectable to the first electric vehicle supply equipment unit via the plug-in charger.

11. An electric vehicle charging station according to claim 1 wherein the wireless charger comprises at least one of: an inductive wireless charger; and a magneto-dynamic coupling wireless charger.

12. An electric vehicle charging station according to claim 2 wherein one or more of the wireless charger, the plug-in charger and the at least one secondary charger is configured to discharge an electric vehicle battery when connected to an electric vehicle.

13. An electric vehicle charging station according to claim 12 wherein power discharged from the electric vehicle battery is directed to a second electric vehicle.

14. An electric vehicle wireless power charger comprising:
a wireless power transmitter physically electrically connectable to a plug-in electric vehicle charger to receive output power therefrom.

15. A method for installing a wireless power charger on a pre-existing plug-in charger, the method comprising:
providing a wireless power charger having a power input connector compatible with an outlet connector of the pre-existing plug-in charger; and
connecting the pre-existing plug-in charger outlet connector to the input connector of the wireless power charger.

16. A method for charging an electric vehicle located in proximity to an electric vehicle charging station, the method comprising:
providing power from a power source to a plug-in charger via a first electric vehicle supply equipment unit, the plug-in charger physically electrically connectable to the electric vehicle;
providing power from the power source to a wireless charger via the first electric vehicle supply equipment unit, the wireless charger wirelessly electrically connectable to the electric vehicle;
charging the electric vehicle by one or more of: a physical electrical connection of the plug-in charger to the electric vehicle and a wireless electrical connection of the wireless charger to the electric vehicle.

17. A method according to claim 16 wherein providing power from the power source to the plug-in charger is simultaneous with providing power from the power source to the wireless charger.

18. A method according to claim 16 comprising:
switching from a first configuration, in which power is provided from the power source to the plug-in charger, to a second configuration, in which power is provided from the power source to the wireless charger.

19. A method according to claim 18 wherein switching from the first configuration to the second configuration comprises connecting an outlet connection of the plug-in charger into an input connection of the wireless charger, thereby establishing a physical electrical connection between the power source and the wireless charger.

20. A method according to claim 16 comprising providing power from the power source to at least one secondary charger via the first electric vehicle supply equipment unit, the secondary charger electrically connectable to the electric vehicle.

21. A method according to claim 20 wherein the at least one secondary charger comprises at least one of:
a secondary wireless charger, the secondary wireless charger wirelessly electrically connectable to the electric vehicle to wirelessly electrically charge the electric vehicle; and
a secondary plug-in charger, the secondary plug-in charger physically electrically connectable to the electric vehicle to physically electrically charge the electric vehicle.

22. A method according to claim 20 comprising distributing power provided to at least two of: the wireless charger, the plug-in charger and the at least one secondary charger, according to a distribution ratio; and wherein the distribution ration is based on at least one of: a charge status of one or more vehicle batteries being charged; and a capacity of one or more of the at least one secondary chargers.

23. A method according to claim 16 comprising simultaneously charging a plurality of electric vehicles by one or more of: a physical electrical connection of the plug-in charger to one of the plurality electric vehicles, a wireless electrical connection of the wireless charger to one of the plurality of electric vehicles and at least one secondary electrical connection of the secondary charger to at least one of the plurality of electric vehicles.

24. A method according to claim 16 wherein the wireless charger comprises at least one of: an inductive wireless charger; and a magneto-dynamic coupling wireless charger.
